(19) United States
(12) Patent Application Publication
(10) Pub. No.: US 2006/0037394 A1
(43) Pub. Date: Feb. 23, 2006

(54) High temperature sensor sleeve

(75) Inventor: Stephen R. Shiffer, Pearl City, IL (US)

Correspondence Address: Intellectual Property;Honeywell International, Inc., 101 Columbia Rd., P.O. Box 2245, Morristown, NJ, 07962, US

(73) Assignee: Honeywell International, Inc.

(21) Appl. No.: 11/049,589

(22) Filed: Feb. 1, 2005

Related U.S. Application Data
(60) Provisional application No. 60/603,329, filed on Aug. 20, 2004.

(51) Int. Cl. G01D 11/24

(52) U.S. Cl. 73/431; 73/866.5; 29/525.14

(57) ABSTRACT

High temperature sensor sleeve includes a sensor housing formed of low coefficient thermal expansion material for holding a sensing device, and a metal housing surrounding the sensor housing. The sensor housing provided in a sleeve-like configuration having inner/outer surfaces providing thermal insulation to sensors held within its center. A metal housing also formed in a sleeve-like configuration has inner and outer surfaces. The inner surface of the metal housing is fused with the outer surface of the sensor housing. The metal housing includes a mechanical interface for securing metal housing to a sensed system. The mechanical interface can include a threaded outer surface and an integrated metal flange formed in a hex nut-like configuration, the flange. The integrated metal flange enables mechanical insertion of the sensor sleeve into a system wherein a hole formed in the system includes complimentary threading for receiving the threaded outer surface of the metal housing.

### FIELD OF THE INVENTION

The present invention is generally related to sensor package fabrication. More particularly, the present invention is related to thermal protective sensor packaging and methods of fabricating sensor housings/packaging that can protect a sensor from high temperature applications.

### BACKGROUND

Sensors are utilized in harsh environments, such as high temperature environments. Sensor can be used, for example, to sense changes in temperature, pressure, moisture, and light. In high temperature applications, sensors can become damaged or unreliable because of surrounding elements. For example, a sensor held within a threaded coupler to be inserted and affixed to a housing that generates heat can be affected if heat from the housing transfers to the sensor. Heat transfer can be disruptive to the sensor's performance, even where the sensor is not measuring thermal properties of the environment.

What is needed are means and/or methods of preventing thermal disruption or damage to sensor used in high temperature environments.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The present invention reduces thermal disruption with sensors in high temperature environments.

In accordance with features of the present invention, a high temperature sensor sleeve includes a sensor housing for holding a sensing device and a metal housing surrounding the sensor housing is provided.

In accordance with a feature of the present invention, a sensor housing is formed of low coefficient of thermal expansion material and is provided in a sleeve-like configuration having inner and outer surfaces. The sensor housing provides thermal insulation to a sensor held within its center.

In accordance with yet another feature of the present invention, a metal housing is provided that is also formed in a sleeve-like configuration and having inner and outer surfaces.

In accordance with an additional feature of the present invention, the inner surface of the metal housing is fused with the outer surface of the sensor housing.

In accordance with another feature of the present invention, the metal housing includes a mechanical interface for securing metal housing to a sensed system.

In accordance with another feature of the present invention, the mechanical interface can include a threaded outer surface and an integrated metal flange formed in a hex nut-like configuration, the flange. The integrated metal flange enables mechanical insertion of the sensor sleeve into a hole formed in a system wherein the hole formed in the system includes complimentary threading for receiving the threaded outer surface of the metal housing.

It is a feature of the present invention to provide a glow plug housing. Material is a shell-like configuration that is thermally insulating to a sensor held within the center of the shell.

It is another feature of the present invention to use an e-beam or laser welder to cause the joining of dissimilar metals while providing for structural, electrical and sealing needs of a system. It can be appreciated that welding methods can include other methods besides e-beam and laser.

Joining diverse metals in accordance with the present invention enables a low coefficient of thermal expansion (low CTE) materials directly surrounding a sensor to be fused with a surrounding sleeve made from stainless or cold rolled steel (CRS), or any other material that is compatible with the low CTE material, sensor and system housing within which the sensor is being utilized (e.g., a glow plug housing). The sleeve will hold the glow plug heater by a brazing process. Plating is required on the carbon steel to prevent it from rusting, but it must be weldable.

In accordance with yet another feature of the present invention, the process can be used for glow plug pressure sensors, NOX, high temperature sensors, and high pressure sensors.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the embodiments disclosed herein.

FIG. 1 illustrates a high temperature sensor in accordance with features of the present invention.

FIG. 2 illustrates use of the invention within a measured environment.

FIG. 3 illustrates a high temperature sensor in accordance with features of the present invention.

FIG. 4 illustrates use of the invention within a measured environment.

FIG. 5 illustrates a high temperature sensor in accordance with features of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

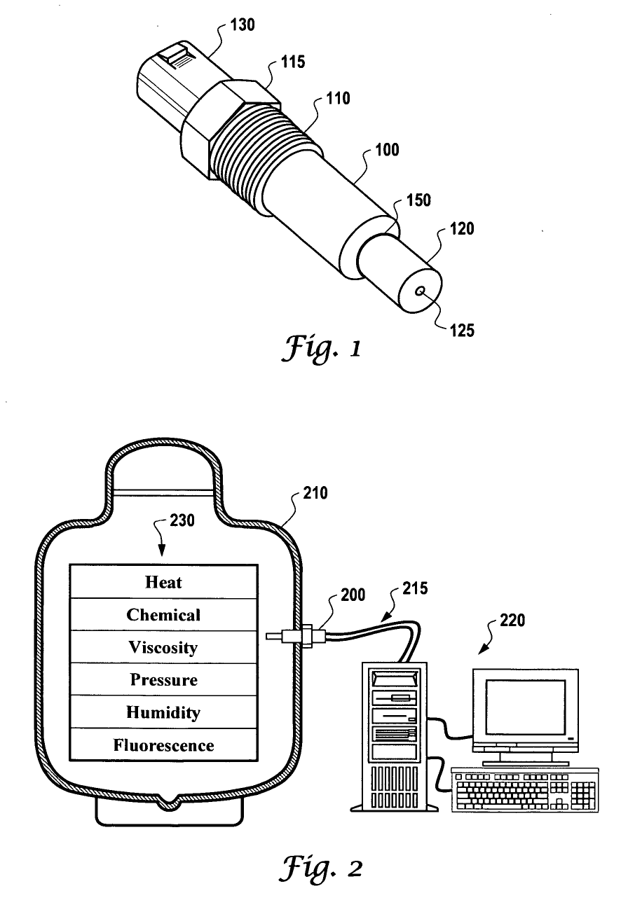

Referring to FIG. 1, a housing 100 made of cold rolled steel is illustrated. The sensor housing has threading 110 formed on its outer perimeter near an integrated hex nut. The housing and integrated hex nut 115 enable the sensor housing and sensor held therein to be screwed into a housing (not shown) that is subject to testing/monitoring. Formed within and fused with the sensor housing 100 is a sensor housing 120 comprised of low CTE sleeve that is surrounded by the housing 100. The low CTE metal sleeve sensor housing 120 and the housing 100 can be fused/welded together as indicated by at location 150 in the drawing. A sensor (not shown) is safely held within the sensor housing 120 where it is protected from direct thermal contact by a system (not shown) and the housing 100, which is in direct contact with the system. Also integrated with the housing 100 and sensor housing 120, opposite a sensor opening 125 is an electrical connector 130. The electrical connector supplies the sensor being held within the CTE metal sleeve with power and signals/data utilized during testing procedures.

The invention looks similar to a glow plug or spark plug; however, the invention does not cause electrical interactivity with the environment being measured within a housing, but is rather collecting data using the sensor. Referring to FIG. 2, a housing 200 is shown mounted within a system housing 210 being monitored by the sensor (not shown) being protected by the housing 200 provided as illustrated in FIG. 1. The sensor is protected within the sensor sleeve 120 of the high temperature housing described in FIG. 1. The sensor carried within housing 200 can be used to measure pressure, heat, moisture, chemical compositions, etc. The sensor is connected to a computer 220 or other means of data collection via electrical connectors, which should be familiar in the art. The system housing 210 contains the environment of interest being monitored or tested by the sensor and computer 220. As shown in the table 230 located within the system environment 210, the sensor can be provided to measure several characteristics of the systems before, during and after operations, such as: heat (thermal), chemical, viscosity, pressure, humidity, fluorescence.

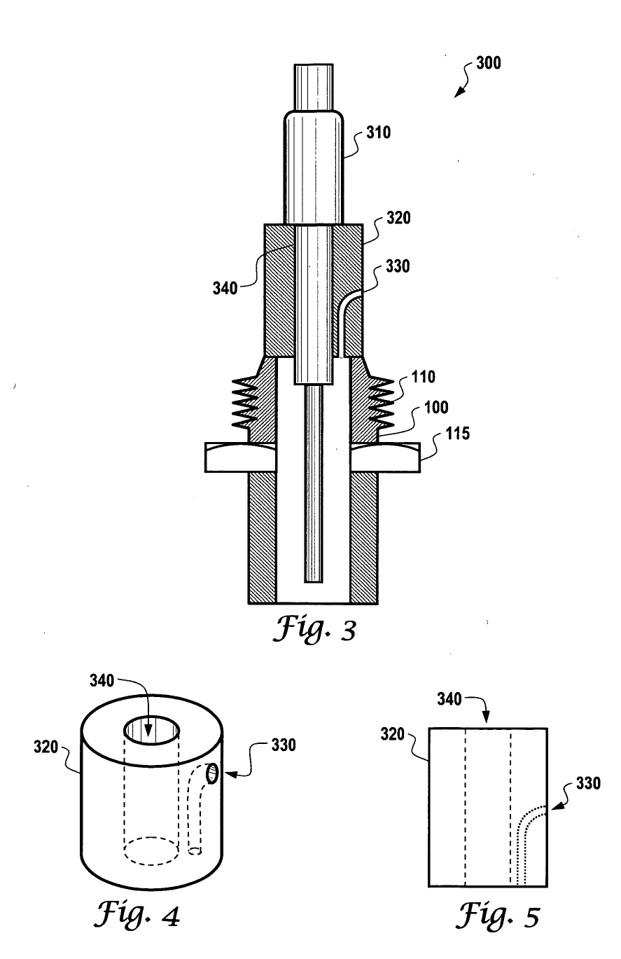

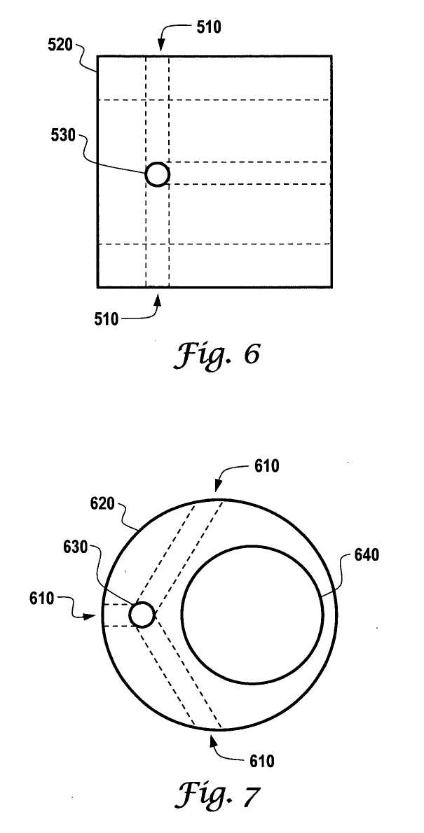

Referring to FIG. 3, a glow plug housing 300 is illustrated. The sensor housing sleeve 340 has main channel 110 formed on its outer perimeter near an integrated hex nut. The housing and integrated hex nut 115 enable the sensor housing and sensor held therein to be screwed into a housing (not shown) that is subject to testing/monitoring. Formed within and fused with the sensor housing 100 is a sensor housing 120 comprised of low CTE sleeve that is surrounded by the housing 100. The low CTE metal sleeve sensor housing 120 and the housing 100 can be fused/welded together as indicated by at location 150 in the drawing. A sensor (not shown) is safely held within the sensor housing 120 where it is protected from direct thermal contact by a system (not shown) and the housing 100, which is in direct contact with the system. Also integrated with the housing 100 and sensor housing 120, opposite a sensor opening 125, is an electrical connector 130. The electrical connector supplies the sensor being held within the CTE metal sleeve with power and signals/data utilized during testing procedures.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A sensor sleeve comprising:
a sensor housing of low coefficient of thermal expansion material formed in a sleeve-like configuration having an inner surface and outer surface, the sensor housing providing thermal insulation to a sensor held within its center; and
a metal housing also formed in a sleeve-like configuration and having a threaded outer surface and an inner surface, the inner surface of the metal housing surrounding the outer surface of the sensor housing, the metal housing also including an integrated metal flange formed in a hex nut-like configuration;
wherein the integrated metal flange enables mechanical insertion of the sensor sleeve into a hole formed in a system wherein the hole formed in the system includes complimentary threading for receiving the threaded outer surface of the metal housing.

2. The invention of claim 1 wherein the metal housing is comprised of at least one of stainless steel or cold rolled steel (CRS).

3. The invention of claim 1 wherein the metal housing also serves as an electrical contact for the sensor held within the low coefficient of thermal expansion metal housing.

4. The invention of claim 3 wherein the metal housing is comprised of at least one of stainless steel or cold rolled steel (CRS).

5. The invention of claim 2 wherein the metal housing also serves as an electrical contact for the sensor held within the low coefficient of thermal expansion metal housing.

6. The invention of claim 1 wherein the outer surface of the sensor housing is fused with the inner surface of the metal housing.

7. The invention of claim 1 wherein the metal housing is comprised of carbon steel and further comprises a layer of plating covering the outer surface of the metal housing to prevent it from rusting.

8. The invention of claim 7 wherein said plating is weldable.

9. A high temperature sensor housing adapted for mechanical insertion of a sensor into a hole formed in a monitored system and sealed attachment to the monitored system, the high temperature sensor housing comprising:
a sensor housing comprised of low coefficient of thermal expansion material formed in a sleeve-like configuration having an inner surface and outer surface, the sensor housing providing thermal insulation to a sensor held within center formed by the inner surface of the sensor housing;
an metal housing also formed in a sleeve-like configuration and having a threaded outer surface and an inner surface, wherein the inner surface of the metal housing is fused with the outer surface of the sensor housing; and
a metal flange formed in a hex nut-like configuration and integrated with the metal housing, wherein the integrated metal flange enables mechanical insertion of the metal housing and a sensor held within the sensor housing and exposed inside the monitored system into the hole formed in the monitored system and wherein the hole formed in the system includes complimentary threading for securely retaining the metal housing by its threaded outer surface.

10. The invention of claim 9 wherein the metal housing is comprised of at least one of stainless steel or cold rolled steel.

11. The invention of claim 9 wherein the metal housing also serves as an electrical contact for the sensor held within the low coefficient of thermal expansion metal housing.

12. The invention of claim 11 wherein the metal housing is comprised of at least one of stainless steel or cold rolled steel.

13. The invention of claim 10 wherein the metal housing also serves as an electrical contact for the sensor held within the low coefficient of thermal expansion metal housing.

14. The invention of claim 9 wherein the metal housing is comprised of carbon steel and further comprises a layer of plating covering the outer surface of the metal housing to prevent it from rusting.

15. The invention of claim 14 wherein said plating is weldable.

16. A method of fabricating a high temperature sensor housing, the method comprising:
providing a low coefficient of thermal expansion material and forming it into a sleeve-like housing having an inner surface that creates a void for placement of a sensing component;
providing a metal housing and forming it into a sleeve-like housing having an inner surface and external surface;
welding the outer surface of the sensor housing and the inner surface of the metal housing wherein the surfaces become fused together while providing for structural, electrical and sealing needs of a monitored system;
forming a mechanical interface on the outer surface of the metal housing, said mechanical interface for securing the sensor housing and sensing component held within the sensor housing to be securely held within a sensed system through a hole formed in a wall associated with the sensed system.

17. The method of claim 16 wherein the mechanical interface further comprises threading formed on the outer surface of the metal housing and a metal flange formed in a hex nut-like configuration and integrated with the metal housing, wherein the integrated metal flange enables mechanical insertion of the metal housing and a sensor held within the sensor housing and exposed inside the monitored system into the hole formed in the wall of the monitored system and wherein the hole formed in the wall includes complimentary threading for securely retaining the metal housing by its threaded outer surface.

18. The method of claim 16 wherein the step of welding includes using at least one of an e-beam welder or laser welder to cause the outer surface of the sensor housing and the inner surface of the metal housing to become fused together while providing for structural, electrical and sealing needs of a monitored system.

19. The method of claim 16 wherein the metal housing is comprised of carbon steel including plating on the outer surface, said plating for preventing the carbon steel from rusting.

20. The method of claim 16 wherein the metal housing is comprised of at least one of stainless steel or cold rolled steel.
